(19) United States
(12) Patent Application Publication
(10) Pub. No.: US 2014/0136043 A1
(43) Pub. Date: May 15, 2014

(54) AUTOMATED DRIVING ASSISTANCE USING ALTITUDE DATA

(71) Applicant: ROBERT BOSCH GMBH, Stuttgart (DE)

(72) Inventor: Pablo Luis Guarnizo Martinez, Novi, MI (US)

(73) Assignee: ROBERT BOSCH GMBH, Stuttgart (DE)

(21) Appl. No.: 13/677,871

(22) Filed: Nov. 15, 2012

(51) Int. Cl. G05D 1/00; G06F 17/00

(52) U.S. Cl. CPC G05D 1/00; G06F 17/00
USPC 701/23; 701/1

(57) ABSTRACT

Systems and methods for performing automated movement of a vehicle. One method includes obtaining a current position of the vehicle including a first location point and a second location point, transmitting the first location point and the second location point to a server over at least one network, and receiving from the server an altitude for the first location point and an altitude for the second location point. The method also includes determining a slope of a driving surface of the vehicle based on the altitude of the first location point, the altitude of the second location point, and a longitudinal distance between the first location point and the second location point. In addition, the method includes determining a vehicle load based on the slope and determining a braking force for automatically stopping the vehicle at a target position based on the slope and the vehicle load.

### SUMMARY

Automated parking systems assist the driver of a vehicle during parking maneuvers. For example, such systems can (i) help the driver search for an available parking space, (ii) indicate to the driver the steering direction along a parking trajectory for parking in a parking space, (iii) warn the driver before collisions with stationary objects in and around the parking space, (iv) automatically steer the vehicle to let the driver concentrate on the gas and brake pedal, and (v) automatically brake the vehicle at a target parking position. In some embodiments, these features are combined in a complete automated parking assistance system that performs an automatic parking maneuver. Furthermore, such assistance systems could be similarly used to assist a driver in performing other maneuvers, such as lane changes, merges, and even traditional driving (e.g., stop and go travel accommodating for traffic signals and other vehicle and objects on the road).

To ensure such automated driving maneuver systems operate properly, the vehicle must be precisely stopped at a desired target position. However, numerous real-world factors, including driving surface slope, can cause the automated systems to imprecisely stop the vehicle at the target position, which can lead to unwanted collisions and uncomfortable (e.g., jumpy) vehicle control.

Therefore, embodiments of the present invention provide systems and methods for improving braking precision based on slope and vehicle load. One provides a system for controlling a vehicle. The system includes a controller configured to obtain an altitude of a first location point of the vehicle and an altitude of a second location point of the vehicle. The controller is also configured to determine a slope of a driving surface of the vehicle based on the altitude of the first location point and the altitude of the second location point and to automatically control the vehicle based at least on part on the slope.

Another embodiment provides a method for controlling a vehicle. The method includes obtaining a current position of the vehicle, wherein the current position includes a first location point of the vehicle and a second location point of the vehicle, obtaining an altitude of the first location point and an altitude of second location point, and determining, at a controller, a slope of a driving surface of the vehicle at the current position of the vehicle based on the altitude of the first location point and the altitude of the second location point.

Yet another embodiment provides a method for performing automated movement of a vehicle. The method includes obtaining a current position of the vehicle based on global positioning signals received by the vehicle, wherein the current position includes a first location point and a second location point. The method also includes transmitting the first location point and the second location point to a server over at least one network, wherein the server stores an altitude model, and receiving from the server an altitude for the first location point and an altitude for the second location point. In addition, the method includes determining, at a controller, a slope of a driving surface of the vehicle based on the altitude of the first location point, the altitude of the second location point, and a longitudinal distance between the first location point and the second location point. The method also includes determining a vehicle load based on the slope and determining a braking force for automatically stopping the vehicle at a target position based on the slope and the vehicle load.

Other aspects of the invention will become apparent by consideration of the detailed description and accompanying drawings.

### BRIEF DESCRIPTION OF THE DRAWINGS

FIG. 1 illustrates a vehicle including a vehicle control system.

FIG. 2 schematically illustrates a controller included in the system of FIG. 1.

FIG. 3 is a flow chart illustrating an automated vehicle control method performed by the controller of FIG. 2.

FIG. 4 schematically illustrates a vehicle obtaining location data and altitude data.

FIG. 5 illustrates a method for using slope and vehicle load to determine a braking force for automatically stopping a vehicle at a target position.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

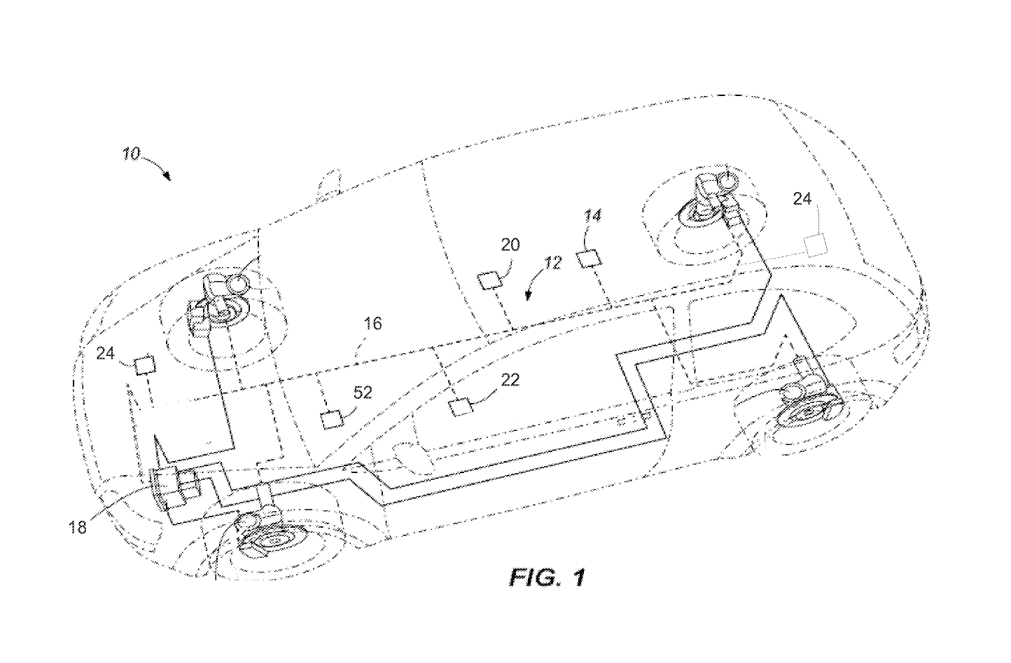

FIG. 1 illustrates a vehicle 10. The vehicle 10 includes a vehicle control system 12. The system 12 includes a controller 14. The controller 14 is connected to a network, such as a controller area network (“CAN”) bus 16. Also connected to the bus 16 are an engine controller 18 and a brake controller 20. In addition, one or more environment sensors (not shown) are connected to the bus 16 that detect the vehicle's surroundings. The environment sensors can include one or more radar, ultrasonic, and/or optical sensors (e.g., one or more cameras) that are mounted on the surface of the vehicle 10 and detect objects located around the vehicle 10 (e.g., other parked cars, a curb, pedestrians, etc.). Although a bus is shown in the vehicle 10, other connections between the components, whether wired, wireless, direct, or indirect, are possible.

Also connected to the bus 16 is a receiver 22. The receiver 22 receives positioning signals from at least one external source, processes the signals to determine a current location of the vehicle 10, and transmits the vehicle's current location to the controller 14 (e.g., over the bus 16 or directly). In some embodiments, the receiver 22 is included in the controller 14. In some embodiments, the receiver 22 receives global positioning system (“GPS”) signals. The GPS is a satellite-based navigation system including a network of satellites placed into orbit by the U.S. Department of Defense. The GPS satellites circle the Earth in a precise orbit and transmit signals to Earth. The receiver 22 receives signals from one or more of the satellites and uses triangulation to calculate the current location of the GPS receiver. In particular, the receiver 22 compares the time a signal was transmitted by a satellite with the time the receiver 22 received the signal. The receiver 22 uses the time difference to determine how far the vehicle 10 is from the satellite. With distance measurements from multiple satellites, the receiver 22 determines the vehicle's current location. In particular, if the receiver 22 receives signals from at least three satellites, the receiver 22 can calculate a two-dimensional location (i.e., latitude and longitude) of the vehicle 10 and can track movement of the vehicle 10. If the receiver 22 receives signals from four or more satellites, the receiver 22 can calculate a three-dimensional location (i.e., latitude, longitude, and altitude) of the vehicle 10. In addition, in some embodiments, the receiver 22 uses the vehicle's current location to calculate other information, such as speed, bearing, distance traveled, distance to destination, sunrise and sunset time, etc. Furthermore, in some embodiments, the receiver displays the vehicle's current location on an electronic map displayed on a screen or user interface within the vehicle 10. Returning to FIG. 1, two or more altimeters 24 (e.g., barometric sensors) are also optionally connected to the bus 16. The altimeters 24 measure atmospheric pressure at various points in the vehicle 10 and transmit the measured pressure over the bus 16.

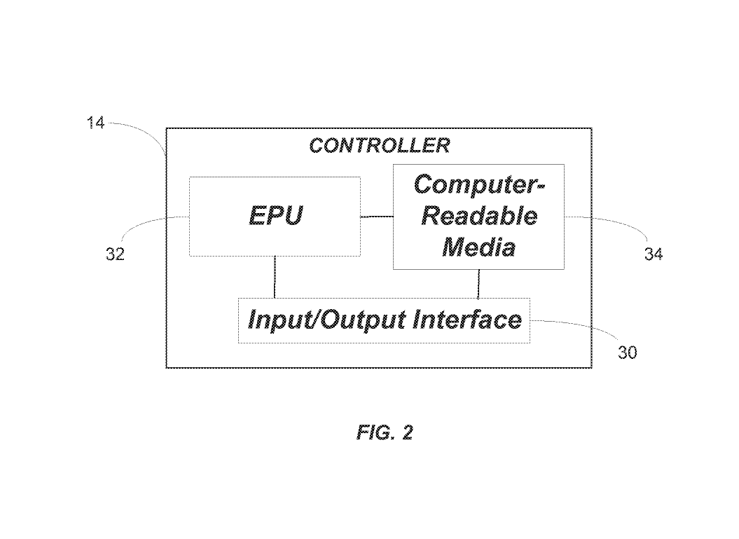

As illustrated in FIG. 2, the controller 14 includes an input/output interface 30, an electronic processing unit (“EPU”) 32, and non-transitory computer-readable media 34. The computer-readable media 34 can include random access memory (“RAM”) and/or read-only memory (“ROM”). The input/output interface 30 transmits and receives information over the bus 16. The input/output interface 30 can communicate with other components inside the vehicle (e.g., over the bus 16) and outside of the vehicle 10. For example, in some embodiments, the input/output interface 30 wirelessly accesses systems remote from the vehicle 10 over a network, such as the Internet.

The EPU 32 receives information from the input/output interface 30 and processes the information by executing one or more instructions or modules. The instructions or modules are stored in the computer-readable media 34. The EPU 32 also stores information (e.g., information received from the bus 16 or information generated by instructions or modules executed by the EPU 32) to the media 34. It should be understood that although only a single EPU, input/output interface, and computer-readable media module are illustrated in FIG. 2, the controller 14 can include multiple processing units, memory modules, and/or input/output interfaces.

The instructions stored in the computer-readable media 34 provide particular functionality when executed by the EPU 32. In general, the instructions, when executed by the EPU 32, perform at least a portion of an automated maneuver of the vehicle 10. In particular, the controller 14 is configured to determine a trajectory for the vehicle for positioning the vehicle at a target position and automatically control the vehicle to position the vehicle at the target position. In particular, the controller 14 uses information from the environment sensors to determine the vehicle's surroundings and determines a trajectory for automatically moving the vehicle 10 to a target position. The controller 14 then transmits commands to the engine controller 18 and the brake controller 20 to automatically move the vehicle 10 along the trajectory to the target position.

In particular, the controller 14 determines a desired traveling speed for the vehicle along the trajectory and transmits the desired traveling speed to the engine controller 18. The controller 14 also automatically controls the steering direction of the vehicle as the vehicle travels along the trajectory. In other embodiments, the controller 14 instructs the driver (e.g., with visual and/or audible instructions) to apply the acceleration pedal to move the vehicle 10 along the trajectory while the controller 14 controls the steering direction or vice versa. In either embodiment, the controller 14 can keep the speed and/or acceleration of the vehicle 10 below a predetermined threshold. For example, in some embodiments, even if the driver presses on the acceleration pedal during the automated maneuver, the controller 14 only allows the vehicle 10 to accelerate up to the predetermined speed threshold and only if additional speed is needed or acceptable during the automated maneuver.

With the vehicle traveling along the trajectory, the controller 14 determines the braking force needed to stop the vehicle 10 at the target position. The controller 14 transmits the requested braking force to the braking controller 20. The braking controller 20 controls the vehicle's brakes according to the requested braking force (similar to when a driver applies an amount of pressure to the vehicle's brake pedal). In some embodiments, the controller 14 uses a display to inform the driver of the current progress of the automated maneuver and to inform the driver when the maneuver is complete and automated control is ending.

As previously noted, precise positioning of the vehicle is desired during automated maneuvers to prevent collisions and uncomfortable (e.g., jumpy) vehicle operation. The slope of the driving surface, however, affects automated braking precision. In particular, assuming the same amount of braking force is applied, a vehicle located on a sharp decline or incline will move more before coming to a standstill than a vehicle located on a flat surface. Therefore, the controller 14 determines the slope of the driving surface to more precisely control the vehicle 10.

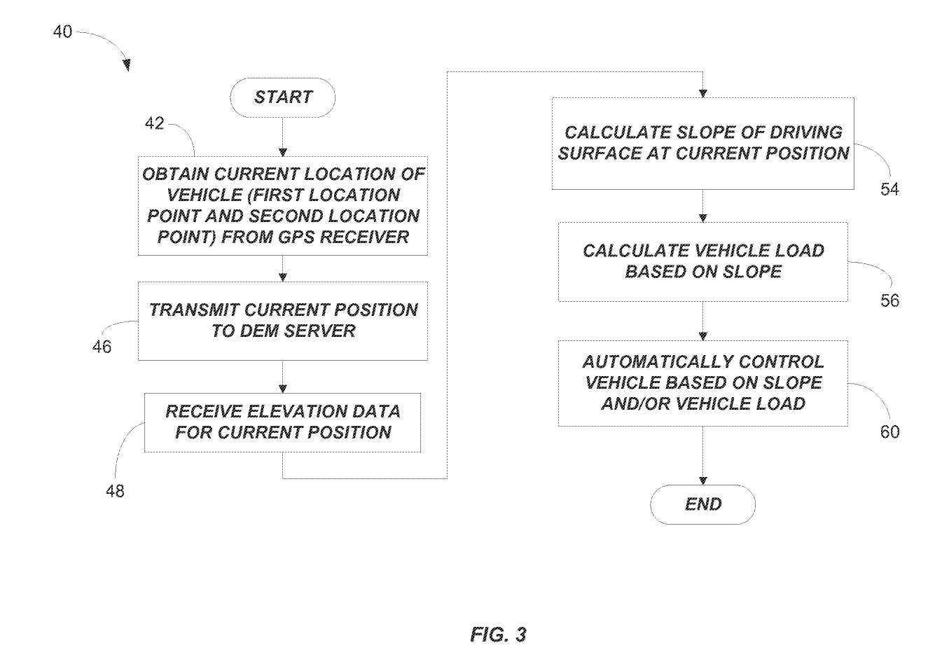

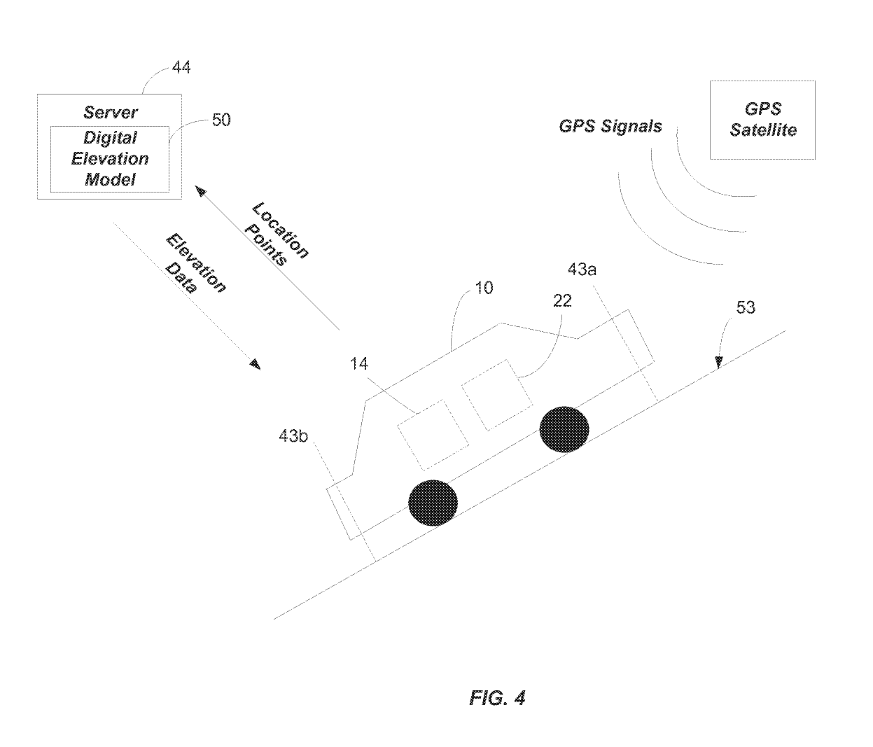

For example, FIG. 3 illustrates an automated vehicle control method 40 performed by the controller 14 that takes into account the slope of the driving surface that the vehicle 10 is located on. To start the method 40, the controller 14 determines the current location of the vehicle 10 (at 42). In some embodiments, the controller 14 receives the vehicle's current position from the receiver 22 (e.g., over the bus 16). As noted above, the receiver 22 can receive GPS signals and can determine the vehicle's current location based on the received signals. The vehicle's current location can include a first location point and a second location point. For example, as illustrated in FIG. 4, the first location point 43a can be located near the front of the vehicle 10 and the second location point 43b can be located near the rear of the vehicle. In some embodiments, the receiver 22 determines the first location point 43a and the second location point 43b directly from the GPS signals. In other embodiments, the receiver 22 (or the controller 14) determines the first location point 43a and the second location point 43b based on the GPS signals and characteristics of the vehicle 10, such as vehicle length. For example, the receiver can determine a current location of a middle position of the vehicle and can calculate the first and second location points 43a and 43b based on the length of the vehicle.

After obtaining the vehicle's current location, the controller 14 determines the vehicle's altitude. In some embodiments, the controller 14 determines the vehicle's altitude by transmitting the vehicle's current location to an external server 44 (see FIG. 4) that stores altitude data (at 46). In particular, the input/output module 30 of the controller 14 transmits the first and second location points 43a and 43b to the server 44 over a network, such as the Internet. The server 44 receives the location points 43a and 43b and transmits an altitude for each of the location points 43a and 43b back to the input/output module 30 (at 48).

In some embodiments, the altitude data stored in the server 44 includes at least one altitude model 50 for at least a portion of the Earth. In some embodiments, the altitude model 50 includes a digital altitude model (“DEM”), which is a digital model or three-dimensional representation of the Earth's surface. DEMs are a type of raster Geographic Information System (“GIS”) layer. Raster GIS represents a surface terrain as a grid-like arrangement of cells where each cell has an altitude value. Therefore, the server 44 matches the coordinates of the location points 43a and 43b transmitted by the controller 14 to points in the DEM and determines the altitude associated with the matching points in the DEM.

It should be understood that in some embodiments, rather than having the input/output module 30 communicate with the server 44, the vehicle 10 can include a transceiver 52 (e.g., connected to the bus 16, see FIG. 1). The transceiver 52 can transmit the vehicle's current location (i.e., the location points 43a and 43b) to the server 44 and receive altitude data from the server 44 as described above. Also, it should be understood that in some embodiments altitude data is stored locally to the vehicle 10, such as in the computer-readable media 34 of the controller 14. In these situations, the controller 14 does not need to access the external server 44 to obtain altitude data.

Furthermore, in some embodiments, as an alternative or in addition to accessing the external server 44, the controller 14 obtains pressure measurements from the altimeters 24. Generally, the lower the atmospheric pressure, the greater the altitude. Therefore, the controller 14 can use the pressure measured by an altimeter 24 positioned at each end of the vehicle 10 to determine the altitude of each end of the vehicle. Therefore, in these embodiments, the altimeters 24 provide similar altitude data as the server 44.

After obtaining the altitude data (e.g., from the server 44, from local storage in the vehicle 10, and/or from the altimeters 24), the controller 14 calculates the slope of the driving surface 53 that the vehicle 10 is positioned on (see FIG. 4) (at 54). For example, in some embodiments, the controller 14 uses altitude data provided in substantially real-time to continuously calculate the slope of the driving surface 53. The controller 14 can use the following geometric relationship to calculate the slope:

$$tan α = \frac{{H}_{2} - {H}_{1}}{\sqrt{{S}_{x}^{2} - {( {H}_{2} - {H}_{1} )}^{2}}}$$

Where H₁ and H₂ are the altitude data for the first and second location points 43a and 43b (i.e., altitude data for a front of the vehicle 10 and altitude data for a rear of the vehicle 10), S_{X} is the longitudinal distance between the two location points 43a and 43b, and α is the slope.

With the slope, the controller 14 can determine other characteristics of the vehicle 10, such as vehicle load or mass (at 58). In particular, the longitudinal vehicle movement equation can be calculated with the following equation:

Mᵥₑₕαᵥₑₕₓ=F_{engine}+Fₛₗₒₚₑ−F_{drag}−Fᵣₒₗₗ−F_{brake}

F_{drag} is calculated using the following equation:

F_{drag}=½ρ·A·C_{d}v²

Where p is air density, A is a frontal area of the vehicle, C_{d} is a drag coefficient for the vehicle, and v is the vehicle's velocity.

Similarly, Fᵣₒₗₗ is calculated using the following equation:

Fᵣₒₗₗ=f(rolling_coefficient,vehicle_mass)

However, the controller 14 can calculate the vehicle load when the vehicle is not braking (by the driver or by a vehicle controller) and is traveling at a low velocity range to make the influence of aerodynamic (F_{drag}) resistance and rolling (Fᵣₒₗₗ) resistance negligible. Therefore, vehicle load or mass (Mᵥₑₕ) can be calculated using the following equation:

$${M}_{veh} = \frac{{F}_{engine}}{{a}_{vehx} - g * sin ( α )}$$

The controller 14 uses the calculated slope and/or vehicle load to more precisely control the vehicle 10 while performing an automated vehicle control (at 60). In particular, the controller 14 uses the calculated slope and vehicle load to reduce the influence of slope during automated braking For example, as described above, the controller 14 determines a braking force for stopping the vehicle at a target position as the vehicle moves along a trajectory. The controller 14 can use the calculated slope and vehicle load to determine a more precise braking force.

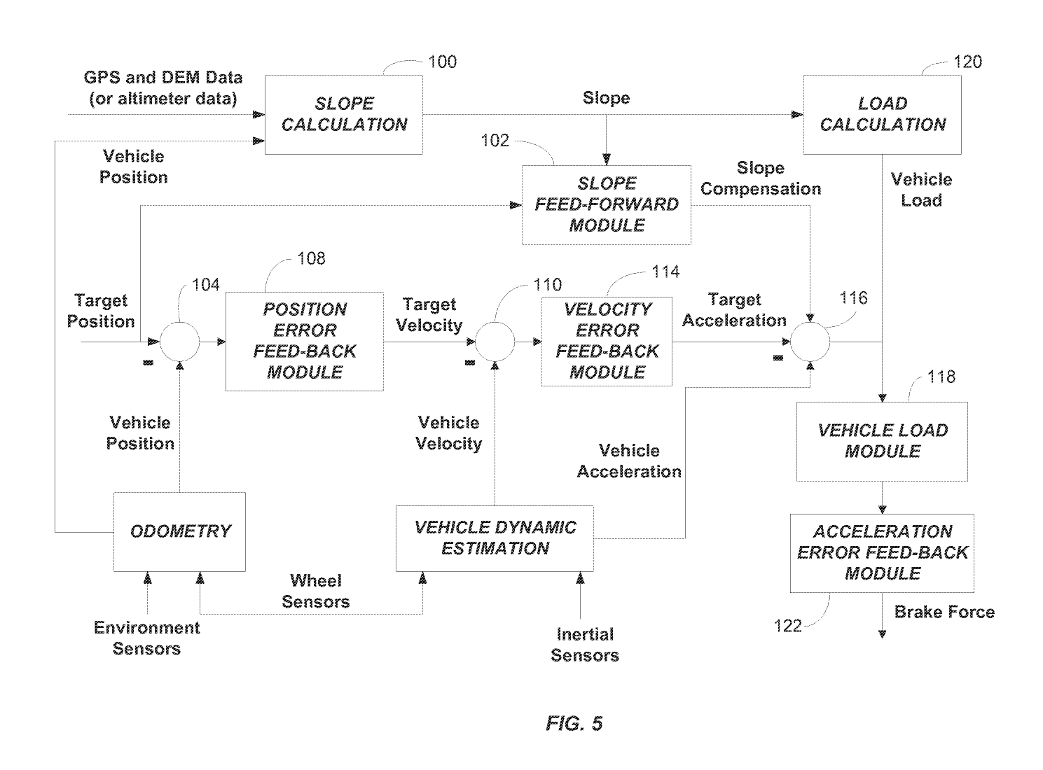

In particular, FIG. 5 illustrates a method 90 for determining a braking force for the vehicle 10 based on slope and vehicle load. As illustrated in FIG. 5, the controller 14 uses the GPS and DEM data (or altimeter data) to calculate the slope as described above (at 100). From the slope, the controller 14 also calculates the vehicle load (at 101). The calculated slope is provided to a slope feed-forward module (at 102). As illustrated in FIG. 5, the slope feed-forward module obtains the slope and the target position and outputs a slope compensation. In some embodiments, the slope compensation is a compensation for a target acceleration.

To determine the target acceleration, the controller 14 can first determine a target velocity. In particular, the controller 14 can compare the target position to a current vehicle position (at 104). In some embodiments, an odometry module provides information representing the vehicle's current position. For example, the odometry module can provide information from the environment or soundings sensors and from wheel speed sensors that can be used to determine the vehicle's current position. As illustrated in FIG. 5, in some embodiments, the controller 14 can also use information from the odometry module (e.g., the vehicle's current position) to calculate the slope.

A position error feed-back module obtains the target position and the vehicle's current position (or the comparison thereof) (at 108). The position error feed-back module can compensate the vehicle position and/or the target position (or the comparison thereof) to account for errors, unknowns, or other variables. The position error feed-back module also outputs the target velocity for the vehicle to move the vehicle from its current position to the target position.

The target velocity is compared with the vehicle's current velocity (at 110). In some embodiments, a vehicle dynamic estimation module provides the vehicle's current velocity based on information from wheel speed sensors and inertial sensors. A velocity error feed-back module also obtains the target velocity and the vehicle's current velocity (or the comparison thereof) (at 114). The velocity error feed-back module can compensate the target velocity and the vehicle velocity to account for any errors, unknowns, or other variables. The velocity error feed-back module also outputs the target acceleration. As noted above, a slope-compensated target acceleration is determined based on the target acceleration and the slope compensation output by the slope feed-forward module (at 116). In some embodiments, as illustrated in FIG. 5, the slope-compensated target acceleration is also determined based on a current vehicle acceleration. A vehicle dynamic estimation module can provide the vehicle's current acceleration based on information from one or more inertial sensors and/or wheel speed sensors.

The slope-compensated target acceleration is fed to a vehicle load module (at 118). The vehicle load module 118 also receives the vehicle load. The vehicle load module outputs a target acceleration (which includes an acceleration or deceleration) for positioning the vehicle at the target position based on the slope and the vehicle load. Therefore, the vehicle load module outputs a slope-and-vehicle-load-compensated target acceleration. The target acceleration output by the vehicle load module is provided to an acceleration error feed-back module (at 122). The acceleration error feed-back module compensates the target acceleration to account for any errors, unknowns, or other variables and outputs a braking force for acquiring the target acceleration. The braking force is provided to the brake controller 20, and the brake controller 20 converts the brake force into brake pressure based on the parameters of the brake calipers and wheels.

It should be understood that in some embodiments the components and modules illustrated in FIG. 5 are included in the controller 14. However, in other embodiments, the components and modules illustrated in FIG. 5 can be included in other controllers or modules separate from the controller 14. For example, the odometry module and the vehicle dynamic estimation module can be provided in an electronic stability control (“ESC”) system separate from the controller 14.

It should also be understood that the configuration of the system 12 illustrated in FIG. 1 is just one possible configuration and that other configurations are possible. Furthermore, it should be understood that slope and vehicle load determined by the controller 14 can be used by other systems included in the vehicle than just an automated assistance system. For example, in some embodiments, an ESC system included in the vehicle obtains altitude, slope, and/or vehicle load information from the controller 14 (e.g., over the bus 16) and uses the information to adjust its operating parameters to more precisely perform stability control for the vehicle 10.

In addition, it should also be understood that the functionality of the controller 14 can be distributed among multiple controllers or modules included in the vehicle 10, including the engine controller 18, the brake controller 20, the receiver 22, and an ESC system. For example, as noted above, in some embodiments, the odometry module and the vehicle dynamic estimation module 112 are included in the vehicle's ESC system. Also, in some embodiments, the controller 14 can be configured to determine a slope of a driving surface and/or a vehicle load and provide the determined information (e.g., over the bus 16) to one or more other controllers configured to automatically control the vehicle 10 (e.g., determine the slope-and-load-compensated braking force as described above).

Therefore, embodiments of the present invention increase the precision of the target braking by determining the slope of the driving surface. Accordingly, the described systems and methods increase the robustness of automated assistance system, which reduces perturbation susceptibility of the system. In addition, the slope and/or vehicle load information can also be used to reduce the reaction time of emergency braking performed during an automated parking maneuver (e.g., to avoid an object on course with the current parking trajectory). In addition, it should be understood that in addition to determining a slope-and-load compensated braking force, the controller 14 can be configured to determine a slope-and-load compensated driving force using a similar method as described above.

Various features and advantages of the invention are set forth in the following claims.

What is claimed is:

1. A system for controlling a vehicle, the system comprising:
a controller configured to obtain an altitude of a first location point of the vehicle and an altitude of a second location point of the vehicle, to determine a slope of a driving surface of the vehicle based on the altitude of the first location point and the altitude of the second location point, and to automatically control the vehicle based at least on part on the slope.

2. The system of claim 1, wherein the controller is further configured to determine a current location of the vehicle based on at least one positioning signal received by the vehicle, the current location of the vehicle including the first location point of the vehicle and the second location point of the vehicle.

3. The system of claim 2, wherein the controller is configured to obtain the altitude of the first and second location points by
transmitting the first and second location points to a server over at least one network, the server storing an altitude model; and
receiving the altitude of the first and second location points from the server over the at least one network.

4. The system of claim 1, wherein the controller is configured to obtain the altitude by
obtaining detected atmospheric pressure from a first altimeter located at the first location point and calculating the altitude of the first location point based on the detected atmospheric pressure from the first altimeter, and
obtaining detected atmosphere pressure from a second altimeter located at the second location point and calculating the altitude of the second location point based on the detected atmospheric pressure from the second altimeter.

5. The system of claim 1, wherein the controller is configured to determine the slope based on the altitude of the first and second location points and a longitudinal distance between the first and second location points.

6. The system of claim 1, wherein the controller is further configured to calculate a vehicle load based on the slope.

7. The system of claim 6, wherein the controller is configured to automatically control the vehicle based on the vehicle load.

8. The system of claim 6, wherein the controller is configured to automatically control the vehicle by determining a braking force for automatically positioning the vehicle at a target position based on the slope and the vehicle load.

9. The system of claim 8, further comprising:
a slope feed-forward module configured to output a slope compensation based on the slope and a current vehicle position;
a position error feed-back module configured to output a target velocity based on target position and the current vehicle position;
a velocity error feed-back module configured to output a target acceleration based on the target velocity, a current vehicle velocity, and a current vehicle acceleration;
a vehicle load module configured to output a compensated target acceleration based on the slope compensation, target acceleration, and vehicle load; and
an acceleration error feed-back module configured to output a braking force based on the compensated target acceleration.

10. The system of claim 9, wherein the slope feed-forward module is further configured to obtain the current vehicle position from an odometry module.

11. The system of claim 9, wherein the velocity error feed-back module is further configured to obtain the current vehicle velocity and the current vehicle acceleration from a vehicle dynamic estimation module.

12. The system of claim 1, further comprising a second controller configured to receive the slope from the first controller and determine a braking force for automatically positioning the vehicle at a target position based on the slope.

13. A method for controlling a vehicle, the method comprising:
obtaining a current position of the vehicle, the current position including a first location point of the vehicle and a second location point of the vehicle;
obtaining an altitude of the first location point and an altitude of second location point; and
determining, at a controller, a slope of a driving surface of the vehicle at the current position of the vehicle based on the altitude of the first location point and the altitude of the second location point.

14. The method of claim 13, wherein obtaining the current position of the vehicle includes obtaining the current position of the vehicle from a global positioning system receiver.

15. The method of claim 13, wherein obtaining the altitude of the first and second location points includes
transmitting the first and second location points to a server over at least one network, the server storing an altitude model, and
receiving from the server over the at least one network the altitude of the first location point and the altitude of the second location point.

16. The method of claim 13, wherein determining the slope includes determining the slope based on the altitude of the first and second location points and a longitudinal distance between the first and second location points.

17. The method of claim 13, further comprising calculating a vehicle load based on the slope.

18. The method of claim 17, wherein calculating the vehicle load includes calculating the vehicle load based on based on the slope, engine force, and vehicle acceleration.

19. The method of claim 13, further comprising determining a braking force for automatically positioning the vehicle at a target position based on at least one of the slope and the vehicle load.

20. A method for performing automated movement of a vehicle, the method comprising:
determining a current position of the vehicle based on positioning signals received by the vehicle, the current position including a first location point and a second location point;
transmitting the first location point and the second location point to a server over at least one network, the server storing an altitude model;
receiving from the server an altitude for the first location point and an altitude for the second location point;
determining, at a controller, a slope of a driving surface of the vehicle based on the altitude of the first location point, the altitude of the second location point, and a longitudinal distance between the first location point and the second location point;
determining a vehicle load based on the slope; and
determining a braking force for automatically stopping the vehicle at a target position based on the slope and the vehicle load.
